(19) United States
(12) Patent Application Publication
(10) Pub. No.: US 2025/0064056 A1
(43) Pub. Date: Feb. 27, 2025

(54) CONTACT PHEROMONE-CONTAINING COMPOSITION FOR CONTROLLING THRIPS, KIT COMPOSITION FOR CONTROLLING THRIPS, AND METHOD OF CONTROLLING THRIPS BY USING SAME

(71) Applicant: Andong National University Industry-Academic Cooperation Foundation, Andong-si (KR)

(72) Inventor: Yong Gyun KIM, Andong-si (KR)

(73) Assignee: Andong National University Industry-Academic Cooperation Foundation, Andong-si (KR)

(21) Appl. No.: 18/588,681

(22) Filed: Feb. 27, 2024

(30) Foreign Application Priority Data
Aug. 25, 2023 (KR) 10-2023-0112188

(51) Int. Cl. A01N 27/00; A01N 43/22; A01P 7/04

(52) U.S. Cl. CPC A01N 27/00; A01N 43/22; A01P 7/04

(57) ABSTRACT

Proposed are a contact pheromone-containing composition, a kit composition, and a method using the same for controlling thrips. A thrip control technology using a behavior-disrupting pheromone is provided to increase opportunities for the exposure of the thrips to pesticides. Contact pheromone (7MT) induced significant behavioral changes in adult thrips. Moreover, the addition of the contact pheromone increased an insecticidal effect. The composition contains the contact pheromone as an active ingredient, and the kit composition contains the contact pheromone of the thrips and pesticides against the thrips. The contact pheromone-containing composition shows a significant control effect on thrips. The kit composition and method, which use a contact pheromone and pesticide together, show a significantly increased control effect compared to the thrips control technologies that only apply existing pesticides.

### STATEMENT REGARDING GOVERNMENT SPONSORED RESEARCH

This invention was supported by the Rural Development Administration of the Republic of Korea. [Research Program name: “Cooperative Research Program for Agriculture Science & Technology Development”; Research Project name: “Development of high-efficient lure based on thrips behavioral physiology and eco-friendly insect pest control through population growth modeling”; Project Serial Number: 1395077308; Research Project Number: PJ01578901]

### CROSS REFERENCE TO RELATED APPLICATION

The present application claims priority to Korean Patent Application No. 10-2023-0112188, filed Aug. 25, 2023, the entire contents of which is incorporated herein for all purposes by this reference.

BACKGROUND OF THE DISCLOSURE

### 1. Field of the Disclosure

The present disclosure relates to thrip control. More specifically, the present disclosure relates to a contact pheromone-containing composition for controlling thrips, a kit composition for controlling thrips, and a method of controlling thrips by using the same.

### 2. Description of the Related Art

Frankliniella occidentalis is widely found around the world, and the insects are pests that cause direct damage to horticultural crops such as vegetables and fruits through the feeding behavior of both larvae and adults (Lacasa and Liorens, 1996; Reitz et al., 2020). The pests also indirectly transmit Tomato spotted wilt virus (TSWV), thereby incurring further losses (Pappu et al, 2009; Webster et al, 2011; Zhao et al, 2014). In particular, peppers among the crops damaged by the pests develop the so-called color disease by Frankliniella occidentalis-mediated transmission of the TSWV virus, thereby enormous economic losses are incurred (Kwon et al., 2018). In Andong, the largest pepper production region in Korea, Frankliniella occidentalis is a dominant species, accounting for more than 80% of the total occurrence density of thrips (Kim et al., 2022). Therefore, thrips is a major pest required to be controlled to pursue stable pepper production.

Various chemical pesticides have been registered and are used to control thrips. Among these pesticides, the chemical agent most commonly used domestically and globally is Spinosad (Jones et al., 2005). Spinosad is a 17:3 mixture of Spinosyn A and Spinosyn D isolated from the culture medium of Saccharomyces spinosa which is a type of actinomycete, and Spinosad acts on an acetylcholine receptor in the central nervous system of insects (Sparks et al, 2008). Spinetoram, which is a Spinosad analog, was developed by mixing Spinosyn J and Spinosin L in a ratio of about 3:1 to increase an insecticidal effect (Dripps et al. 2008). However, frequent treatment of such chemical agents with a similar action point caused pesticide resistance based on desensitization of the action point (Wan et al, 2018). This development of pesticide resistance naturally led to the development of non-chemical technologies for controlling thrips. Moreover, Frankliniella occidentalis has a behavioral habit of hiding in the crevices of their hosts, making it difficult for the pests to be exposed to sprayed pesticides. Therefore, even when there is a chemical agent with a high insecticidal effect, the control efficiency is low (Reitz et al., 2020). To overcome these difficulties in controlling the pests, the use of pheromones for behavior disruption and pest control has been proposed (Kirk et al., 2021).

Various pheromones were discovered from Frankliniella occidentalis. First, for exploitation of host plant and reproductive mating, adult males excrete aggregation pheromones to attract both sexes (Hamilton et al., 2005). Two pheromone components were identified from the aggregation pheromones. While exploring the biosynthetic process of these pheromone components, the findings that biosynthesis of these substances occurs in both males and females and that females also release the aggregation pheromones were recently reported. (Khan et al., 2023). In addition, it was found that alarm pheromones secreted by larvae are volatile substances with relatively low molecular weight such as decyl acetate (10:Ac) and dodecyl acetate (12:Ac), and that the alarm pheromones caused avoidance behavior displayed not only in larvae but also in adults (Teerling et al., 1993). Accordingly, the alarm pheromones were used for thrip control around the fences of the facilities for cultivation areas (Kim et al., 2023). Contact pheromones mainly exist as lipid substances in the body wall. It was reported that 7-methyltricosane is a hydrocarbon present in greater amounts in the body wall of adult male Frankliniella occidentalis than in adult female Frankliniella occidentalis, and the 7-methyltricosane acts as a contact pheromone that allows adult females to recognize adult males.

### [DOCUMENTS OF RELATED ART]

(Patent Document 0001) International Publication WO WO2022/061156

(Patent Document 0002) Korean Patent Registration 2131333

(Non-patent Document 0001) Kirk, W.D.J., de Kogel, W.J., Koschier, E.H., Teulon, D.A.J., 2021. Semiochemicals for thrips and their use in pest management. Annu. Rev. Entomol. 66, 101-119

(Non-patent Document 0002) Reitz, S.R., Gao. Y., Kirk, W.D.J., Hoddle, M.S., Leiss, K.A., Funderburk, J.E., 2020. Invasion biology, ecology, and management of western flower thrips. Annu. Rev.

Entomol. 65, 17-37

(Non-patent Document 0003) Olaniran OA, Sudhakar AV, Drijfhout FP, Dublon IA, Hall DR, Hamilton JG, Kirk WD., 2013. A male-predominant cuticular hydrocarbon, 7-methyltricosane, is used as a contact pheromone in the western flower thrips Frankliniella occidentalis. J. Chem. Ecol. 39, 559-568

### SUMMARY OF THE DISCLOSURE

A variety of chemical pesticides are registered and commercially available to target thrips that harms crops (Park et al., 2019; Kim et al., 2022). Chemical pesticides have been widely used as an essential control method for managing crops thanks to the relatively high insecticidal ability of the chemical pesticides. However, the development of pesticide resistance in thrips led to the administration of more toxic agents to the agricultural ecosystem and the resultant environmental pollution, as well as a heavier economic and scientific burden for the need to develop chemical agents with new mechanisms of action. Moreover, given the behavioral habits of thrips, thrips tend to hide in narrow crevices by taking advantage of the relatively small size thereof. The habit reduces the exposure of thrips to chemical agents sprayed on crops, making it more difficult to effectively control thrips through pesticide treatment.

The present disclosure seeks to provide a control technology that uses a behavior-disrupting pheromone to further expand opportunities for the exposure of thrips to pesticides by the pheromone disrupting the seclusion behavior of thrips. Thus, the present disclosure is to provide a composition for controlling thrips, the composition containing a behavioral disruption pheromone. In addition, a kit composition further containing a pesticide for controlling thrips, and a method of controlling thrips using the same are also provided.

The present disclosure provides a composition for controlling thrips, the composition containing a contact pheromone of the thrips as an active ingredient. The contact pheromone preferably contains 7-methyltricosane (7TM). The thrips preferably include Frankliniella occidentalis or Frankliniella intonsa.

The present disclosure provides a kit composition for controlling thrips, the kit composition containing a contact pheromone of thrips and pesticide against thrips. The contact pheromone preferably contains 7-methyltricosane (7TM). The pesticide preferably includes Spinetoram or Spinosad. The thrips preferably include Frankliniella occidentalis or Frankliniella intonsa.

In addition, the present disclosure provides a method of controlling thrips including: spraying a contact pheromone of thrips onto the thrips to disrupt behaviors; and spraying a pesticide onto the thrips. The contact pheromone preferably contains 7-methyltricosane (7TM). The thrips preferably include Frankliniella occidentalis or Frankliniella intonsa.

As confirmed through examples in the present disclosure, contact pheromone (7MT) had no effect on larvae but caused distinct behavioral changes in adults. In the examples, female Frankliniella occidentalis preferred feed treated with the contact pheromone, while males avoided the same treated feed, and similar results were obtained in the study with Frankliniella intonsa, a sibiling species. When the contact pheromone was applied to Frankliniella intonsa, its density was statistically significantly reduced.

Moreover, the addition of the contact pheromone to the pesticides increased the insecticidal effect of the pesticides. Treatment with pesticide Spinetoram showed a clear control effect on both Frankliniella occidentalis and Frankliniella intonsa, and when the contact pheromone was added, the control effect significantly increased on both thrips.

According to the present disclosure, a composition for controlling thrips, the composition containing the contact pheromone of thrips as an active ingredient shows a significant control effect against thrips, especially Frankliniella intonsa. In addition, the kit composition and control method for controlling thrips of the present disclosure, which use contact pheromones and pesticides together, show a significantly increased control effect compared to the thrips control technologies that only apply existing pesticides.

### BRIEF DESCRIPTION OF THE DRAWINGS

FIGS. 1A, 1B, and 1C show the results of behavioral tests in a container for behavior analysis (A) for two types of thrips (F. occidentalis (B) and F. intonsa (C)), in the container for behavior analysis (A), a soybean diet placed on a filter paper disk was treated with 7-methyltricosane (7TM), the control diet was treated with acid solvent, after 10 minutes, the number of thrips that reached each feed was counted, each treatment was repeated four times by exchanging the positions of the treatment and control groups, asterisk indicates a significant difference with type I error=0.05 (LSD test), and “NS” means no significant difference; and

FIG. 2 is a test result showing the control effect of a mixture of 7-methyltricosane (7TM, 100 μg/μl) and Spinetoram (SP, 25 μg/μl) against thrips that attack peppers in the open field, control group (CON) indicates no spraying, the peppers were experimental, the total number of the thrips was counted on each plant on days 0, 1, and 3 after treatment, and each treatment was repeated three times in a randomized block design.

### DESCRIPTION OF THE PREFERRED EMBODIMENTS

Thrips are small insects that live in narrow crevices, so the thrips are often difficult to be exposed to sprayed pesticides. In the present disclosure, the present inventors attempted a control technology to prevent the seclusion behavior and enhance the control effect by using a contact pheromone for behavior disruption, and the present inventors analyzed the control effect of the technology.

Contact pheromones of Frankliniella occidentalis mainly exist as lipid substances in the body wall. It was reported that 7-methyltricosane (7TM) is a hydrocarbon present in greater amounts in the body wall of adult male Frankliniella occidentalis than in adult female Frankliniella occidentalis, and the 7-methyltricosane (7TM) acts as a contact pheromone that allows adult females to recognize adult males (Olaniran et al., 2013). This substance had an adult female ready for mating posture by recognizing an adult male meanwhile the substance acted as a mutual recognition substance among adult males inducing aggressive behavior against one another. Therefore, in the present disclosure, the present inventors assumed that exposure to this contact pheromone substance could disrupt the behavior of Frankliniella occidentalis.

In the present disclosure, the present inventors developed a hypothesis that an increase in the pests' contact with pesticides through a contact pheromone could disrupt the behavior of Frankliniella occidentalis and finally improve control efficiency. Afterward, experiments were conducted to prove the hypothesis. For the research, the behavioral responses of larvae and adults to contact pheromones were analyzed. Based on the analysis, the present inventors used a chemical agent named Spinetoram having an insecticidal effect against Frankliniella occidentalis, and then compared and analyzed the control effect of a chemical agent/contact pheromone mixture and the control effect of a stand-alone pesticide in outdoor pepper cultivation areas.

Specifically, in the present disclosure, feed was treated with 7-methyltricosane (7TM), and a bio-assay was conducted to see the presence or absence of behavioral disruption. This contact pheromone had no effect on the larvae, but induced adult males to avoid the treated feed. On the other hand, 7TM actually induced adult females to move to the treated area. Similar behavioral changes, when with the same contact pheromone, were observed in the study with a flower thrips (Frankliniella intonsa). From there, the behavioral changes of thrips caused by 7TM were associated with pesticide treatment, and the control effect of a 7TM/pesticide mixture on thrips attacking peppers was tested. The test showed that the treatment of the 7TM/pesticide mixture increased the thrip control efficiency, compared to the treatment with pesticide Spinetoram alone. What was interesting is that the treatment with 7TM alone showed some reduction in the density of Frankliniella intonsa, supporting the fact that 7TM disrupts the behavior of thrips.

Based on these results, the present disclosure provides a new pest control technology that increases the control effect by mitigating pesticide avoidance behavior of thrips through contact pheromone treatment.

The composition for controlling thrips of the present disclosure contains the contact pheromone of thrips as an active ingredient.

The thrips are not particularly limited but may include Frankliniella occidentalis or Frankliniella intonsa.

When the control target includes Frankliniella occidentalis or Frankliniella intonsa, the contact pheromone preferably contains 7-methyltricosane (7TM). However, the contact pheromone may vary depending on the type of thrips, so the contact pheromone is not limited to 7TM.

The kit composition for controlling thrips of the present disclosure contains a contact pheromone of the thrips and a pesticide against thrips.

The description of each thrip and contact pheromone is the same as the description of the composition for controlling thrips.

The pesticide can be any pesticide that has an insecticidal effect against thrips and is not particularly limited. A variety of chemical pesticides known to be effective in controlling thrips can be used, and new pesticides that are not yet known can also be used. Preferably, pesticides containing Spinetoram or Spinosad, which are currently known to have an excellent insecticidal effect against thrips, can be used.

The method of controlling thrips of the present disclosure includes:
spraying a contact pheromone of thrips onto the thrips to disrupt behaviors; and
spraying a pesticide onto the thrips.

Each description of the thrips and contact pheromone is the same as the description of the composition for controlling thrips.

### [Examples]

The present disclosure will be described in detail below through examples. These examples illustrate the present disclosure and the scope of the present disclosure is not limited thereto.

1. Materials and methods

1) Indoor breeding of test insects

Frankliniella occidentalis was distributed from the Crop Protection Division of the Rural Development Administration National Institute Agricultural Sciences and reared indoors under the following conditions: a temperature of 25±2° C., relative humidity of 65±5%, and a 14-hour photoperiod. Frankliniella occidentalis was bred from eggs to adults using a round breeding container (diameter of 100 mm and height of 40 mm). Kidney beans (Phaseolus coccineus) germinated for 5 days were provided to larvae and adults as feed. Frankliniella intonsa was obtained from pepper production areas located in Goesan-gun, Chungcheongbuk-do, and propagated indoors under the breeding conditions.

2) Test substances

7-Methyltricosane (7MT) was synthesized by AD Co., Ltd. located in Andong, Gyeongsangbuk-do based on an order of the present inventors. The synthesized 7TM was dissolved in hexane and prepared to have a test concentration. Pesticide Spinetoram was purchased from Dongbang Agro as a suspension concentrate (SC) formulation (product name: Exult).

3) Behavioral test

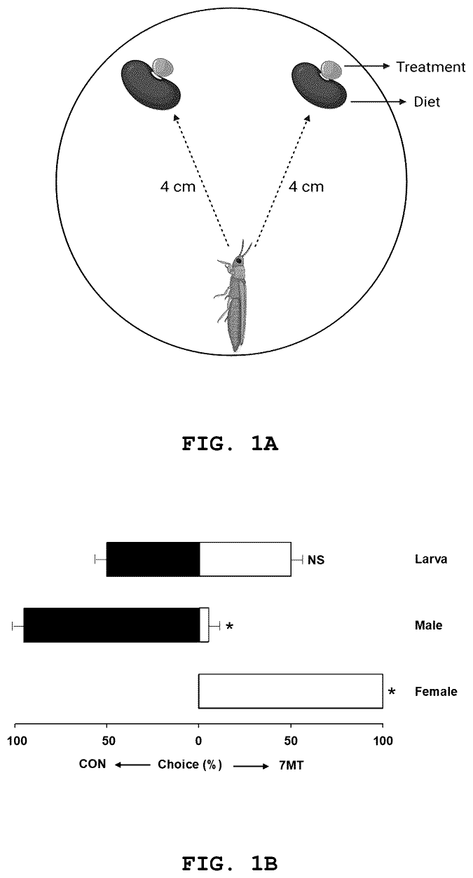

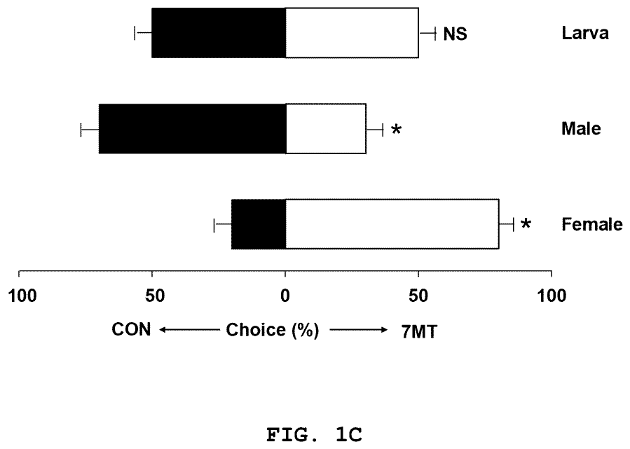

A petri Dish (Life Science, Seoul) with a size of 90 x 15 mm was used as a behavioral test site (shown in FIG. 1(A)). A filter paper was unfolded in the behavior test site, and two kidney beans were placed away at a distance of 50 mm as bait. Each of the test substances was applied on top of each feed. In the test substance treatment, 10 μL of 7TM substance was sprayed onto 5 mm circular filter paper. In the case of the control group, the same volume of hexane was sprayed onto a filter paper as a test substance. Each circular filter paper differently treated was placed on any one of the two kidney beans. Next, test individuals were placed in the center 40 mm away from both feed sources. Afterward, the individuals having reached each feed were counted for 10 minutes at room temperature. 10 individuals were used in each test, and each test was repeated 4 times. The positions of the control group and the treatment group were exchanged in each repetition. The thrips used in the test were second-instar larvae and adults within 3days after emergence.

4) Outdoor pest control tests

Each treatment was repeated three times using the egg mass method in open pepper production areas located in Songcheon-dong, Andong-si, Gyeongsangbuk-do. Each test group was pepper individuals, and the distance between these individuals was maintained at least 6 m. The amount of chemical agent sprayed on each pepper individual was 30 mL, and the chemical agent was sufficiently sprayed on the entire peppers. There were two separate treatments, one with 0.01% 7MT and the other with 250 ppm spinctoram. In addition, there was a blend treatment with a 0.01% 7MT/250 ppm Spinetoram mixture. The control group was treated with a distilled chemical agent. The density of thrips was calculated before treatment and on days 1 and 3 after treatment. The classification of these three different thrips was carried out by using the shape identification method presented by Kim et al. (2021).

5) Statistical analysis

For the indoor behavioral experiment, one-way ANOVA analysis was performed using PROC GLM (SAS Institute, 1989). The effectiveness of outdoor pest control was confirmed by calculating the survival rate and performing arsine transformation and two-way ANOVA analysis. Comparison between treatment means was determined based on a Type I error probability of 0.05 using an LSD method.

2. Results

1) Behavioral response of thrips to contact pheromones

To analyze the behavioral responses of thrips with affinity for a contact pheromone, a behavior analysis container (shown in FIG. 1(A)) was manufactured using a petri dish. The results are shown in FIGS. 1B and 1C. Thrips were prepared to be near the treated feed, and after inducing the behavioral responses for 10 minutes, some of the thrips staying near the pheromone-treated feed were counted. As a result, the larvae of both thrips species did not show specific selection behavior (FIGS. 1(B) and 1(C)). On the other hand, in the case of adult insects, adult males and females showed conflicting behavioral responses. While adult males showed a response of avoiding feed sprayed with the contact pheromone, adult females showed a high preference.

2) Increased Spinetoram control efficiency using contact pheromone

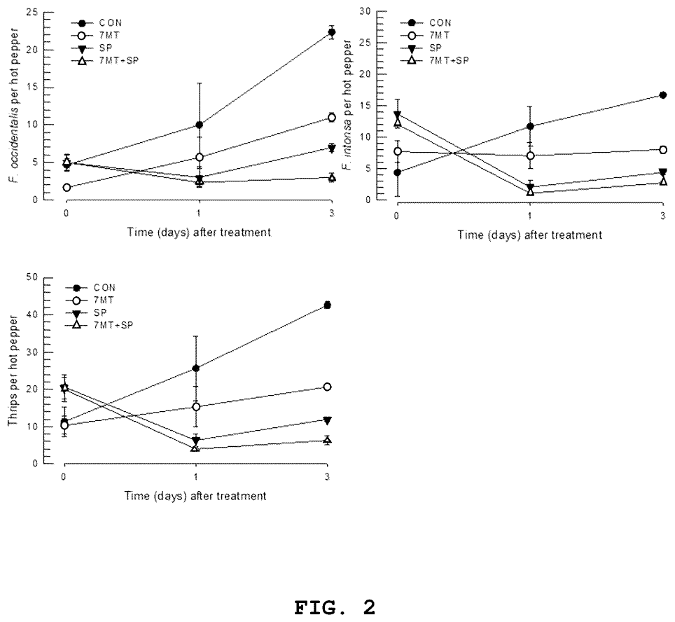

A test was conducted to check the outdoor control efficiency by adding a contact pheromone causing behavior disruption to Spinetoram having a relatively high control efficiency against thrips. The results are shown in FIG. 2. At the end of May 2023, when the test was conducted, Frankliniella occidentalis and Frankliniella intonsa appeared around peppers in open areas in the Andong region. By taking advantage of this situation, treatment with a chemical agent alone and treatment with a chemical agent/contact pheromone mixture were implemented. In the untreated control group, an increase in the density of two thrips was observed. However, in the mixed treatment with Spinetoram, an overall decrease in the density was clearly observed.

To analyze the results in detail, a control value on the 3rd day of treatment was calculated. Table 1 shows the results of calculating the control value for thrips invading peppers in the field 3 days after treatment with a mixture of 7-methyltricosane (7MT) and Spinetoram. The average survival rate was lowered in all treatment cases compared to no treatment cases. When treated with the contact pheromone, the density of Frankliniella intonsa was statistically significantly reduced, but it was not in the case of Frankliniella occidentalis. The Spinetoram treatment showed a clear control effect on both thrips, recording a control value of 71.9% for Frankliniella occidentalis and 80.3% for Frankliniella intonsa. At this time, when the contact pheromone was added, the control value increased for both thrips. When checking the control value based on all thrips, treatment with Spinetoram alone showed a control value of 76.2%, but the treatment with the contact pheromone/Spinetoram mixture showed an increased control value of 86.2%.

TABLE 1

| | | Thrips before | | | | | | Contol |
|---|---|---|---|---|---|---|---|---|
| | Dose (a.i. | treatment per | Survival (%) | | | | | efficacy |
| Treatment | μg/mL) | plant | I | II | III | Mean | DMRT¹ | (%) |

F. occidentalis

| | | | | | | | | |
|---|---|---|---|---|---|---|---|---|
| Control | — | 4.7 | 733.3 | 350.0 | 480.0 | 521.1 | a | — |
| 7MT | 100 | 3.4 | 500.0 | 300.0 | 275.0 | 358.3 | a | 31.2 |
| Spinetoram | 12.5 | 5.0 | 150.0 | 175.0 | 114.3 | 146.4 | b | 71.9 |
| 7MT + | 100 + | 5.0 | 42.9 | 40.0 | 133.3 | 72.1 | c | 86.2 |
| Spinetoram | 12.5 | | | | | | | |

F. intonsa

| | | | | | | | | |
|---|---|---|---|---|---|---|---|---|
| Control | — | 10.0 | 170.0 | 200.0 | 141.7 | 170.6 | a | — |
| 7MT | 100 | 7.7 | 133.3 | 150.0 | 63.6 | 115.7 | b | 32.2 |
| Spinetoram | 12.5 | 13.7 | 40.0 | 22.2 | 38.5 | 33.6 | c | 80.3 |
| 7MT + | 100 + | 12.0 | 25.0 | 16.7 | 25.0 | 22.2 | c | 87.0 |
| Spinetoram | 12.5 | | | | | | | |

Total thrips

| | | | | | | | | |
|---|---|---|---|---|---|---|---|---|
| Control | — | 17.0 | 293.3 | 241.2 | 226.3 | 253.6 | a | — |
| 7MT | 100 | 10.3 | 300.0 | 233.3 | 133.3 | 222.2 | a | 12.4 |
| Spinetoram | 12.5 | 20.6 | 73.3 | 46.2 | 61.1 | 60.5 | b | 76.2 |
| 7MT + | 100 + | 20.0 | 26.9 | 21.1 | 53.3 | 33.8 | c | 86.7 |
| Spinetoram | 12.5 | | | | | | | |

3. Conclusion

Contact pheromone (7MT) had no effect on larvae but caused distinct behavioral changes in adults. In the experiment using a behavior analysis device, adult females were found to be attracted to a treatment area, whereas adult males were found to display different responses of avoiding the treatment area. This substance was isolated from the body wall of an adult male Frankliniella occidentalis by treatment of hexane, which is an organic solvent, and the substance is considered a male-specific lipid substance (Olaniran et al., 2013). In other words, it is presumed that adult females recognize adult males by using the substance exposed through contact whereas adult males communicate with other adult males by taking the substance as a competitive signal. Therefore, it is considered that adult females preferred feed treated with this substance while males avoided the substance. What was interesting is that in experiments with this substance, similar results were obtained in the study with Frankliniella intonsa, which is a similar species to Frankliniella occidentalis. Although contact pheromones excreted from Frankliniella intonsa have not yet been reported, it is considered that 7MT acts as a contact pheromone and mediates male and female behavioral responses by being present as a male-specific substance for Frankliniella intonsa.

The addition of the contact pheromone to pesticide Spinetoram increased the insecticidal effect of this pesticide. Spinetoram, which is a pesticide from the Spinosad family, was registered in 2007 and has been applied to a variety of pests, showing faster killing ability and longer residual efficacy than existing Spinosad (Shimokawatoko et al. 2012; Bacci et al. 2016). Spinetoram, like Spinosad, is a neurotoxin that has an action point on a nicotinate acetylcholine receptor (nAChR) of insects (Sparks and Nauen, 2014). The resistance mechanism of thrips to this chemical agent makes changes in the action point, which attracts attention. It is known that the cause is a point mutation in some monomers (α6) of the nAChR, which is the action point of Spinosad, and the point mutation ultimately results in an amino acid substitution (Gly→Glu) and a change in the binding between the chemical agent and the action point (Puincan et al., 2013). In addition, there is the occurrence of cross-resistance in thrips against pesticides with relatively different action points. The resistance is considered to have been made since the activity of detoxification enzymes increases, the activity being caused by chemical substance metabolism-promoting reactions such as a monooxygenase-mediated reaction (Espinosa et al., 2005). All in all, thrips have developed complex resistance mechanisms such as changes in the action points and an increase in activated detoxification enzymes against chemical agents, making it difficult to control thrips with the chemical agents. In the present disclosure, a contact pheromone was used to disrupt the seclusion behavior of thrips, the behavior serving as another obstacle to achieving an effective insecticidal effect. Consequently, it is considered that the addition of the contact pheromone induced an increased insecticidal effect since the contact pheromone disrupted seclusion behavior and increased exposure of thrips to chemical agents, which finally enhanced the control effect.

The contact pheromone-containing composition for controlling thrips of the present disclosure described above, the kit composition for controlling thrips, and method for controlling thrips using the same are illustrative. Those ordinarily skilled in the art to which the present disclosure pertains will appreciate that various modifications and other equivalent embodiments are possible. Therefore, it will be well understood that the present disclosure is not limited to the forms mentioned in the description of the disclosure above. The true technical protection scope of the present disclosure shall be determined by the technical spirit of the claims and is understood to include all modifications, equivalents, and substitutes within the spirit and scope of the present disclosure defined by the claims of the present disclosure.

Additionally, terms or words used in this specification and claims should not be construed as limited to their usual or dictionary meanings. Based on the principle that the inventors can appropriately define the concept of the term to explain his or her disclosure in the best way, it should be interpreted as having a meaning and concept consistent with the technical idea of the present disclosure.

What is claimed is:

1. A composition for controlling thrips, the composition comprising a contact pheromone of the thrips as an active ingredient.

2. The composition of claim 1, wherein the contact pheromone comprises 7-methyltricosane (7TM).

3. The composition of claim 1, wherein the thrips comprise Frankliniella occidentalis or Frankliniella intonsa.

4. A kit composition for controlling thrips, the kit composition comprising a contact pheromone of thrips and pesticide against thrips.

5. The kit composition of claim 4, wherein the contact pheromone comprises 7-methyltricosane (7TM).

6. The kit composition of claim 4, wherein the pesticide comprises Spinetoram or Spinosad.

7. The kit composition of claim 4, wherein the thrips comprise Frankliniella occidentalis or Frankliniella intonsa.

8. A method of controlling thrips comprising:
spraying a contact pheromone of thrips onto the thrips to disrupt behaviors; and
spraying a pesticide onto the thrips.

9. The method of claim 8, wherein the contact pheromone comprises 7-methyltricosane (7TM).

10. The method of claim 8, wherein the thrips comprise Frankliniella occidentalis or Frankliniella intonsa.
